(19) United States
(12) Patent Application Publication
(10) Pub. No.: US 2015/0292546 A1
(43) Pub. Date: Oct. 15, 2015

(54) CAPTIVE FASTENER ASSEMBLY AND METHOD

(71) Applicant: ADALET/SCOTT FETZER COMPANY, CLEVELAND, OH (US)

(72) Inventors: MATTHEW R. DERR, WESTFIELD CENTER, OH (US); THOMAS JAMES, PARMA HEIGHTS, OH (US); JOHN JONSCHER, ESTERO, FL (US)

(21) Appl. No.: 14/682,438

(22) Filed: Apr. 9, 2015

Related U.S. Application Data
(60) Provisional application No. 61/977,367, filed on Apr. 9, 2014.

(51) Int. Cl. F16B 39/24; B65D 6/34

(52) U.S. Cl. CPC F16B 39/24; B65D 7/44

(57) ABSTRACT

A captive fastener assembly and method comprising a retaining plate for positioning upon a perimeteral surface of a cover of an enclosure during use, the retaining plate comprising a plurality of plate openings having an inner diameter for the passage of a plurality of respective captive fasteners. The captive fastener assembly further comprises a plurality of respective securing rings having inner and outer diameters, the plurality of capture fasteners comprising an annular notch for fixedly attaching to the inner diameter of the securing ring during use, wherein the outer diameter of the securing rings is greater than the inner diameter of the plate openings.

### CROSS-REFERENCE TO RELATED APPLICATIONS

The present application claims priority under 35 U.S.C. §119(e) to U.S. Provisional Patent Application Ser. No. 61/977,367 filed Apr. 9, 2014 entitled CAPTIVE FASTENER ASSEMBLY AND METHOD. The above-identified provisional application is incorporated herein by reference in its entirety for all purposes.

### FIELD OF THIS DISCLOSURE

The present disclosure relates to a captive fastener assembly method and more specifically, a captive fastener assembly and method for securing first and second portions of a cover to form a single enclosure with one more fasteners, while retaining said fasteners to the enclosure should any one of the fasteners become disengaged.

### BACKGROUND

Captivating bolts has advantages such that it prevents bolts from being lost or displaced when conditions allow the bolts to become loose or disengaged. This is particularly important when the bolts could become displaced into moving equipment, such as motors and the like.

One known method for captivating bolts is by using a non-metallic insert. This insert is held in a counter bore on the inside of the cover. The bolt then threads through the insert. The insert holds the bolt in place in the cover. Generally, one problem with this method is that it is often difficult to thread the bolt through the insert. As a result, damage can occur to the cover from the use of too much force to tighten the bolts. Another problem that can arise with this method is that it is often relatively easy to unthread the bolt all of the way out of the insert. This results in loss of the captivation of the bolt. Additionally, over time, wear on the insert can result in the loss of captivity of the bolt.

While another method for captivating bolts is the use a reduced shank bolt. In this method, the cover has specially machined holes that have a few threads near the outside surface of the cover and a larger counter bore on the inside surface of the cover. As the reduced shank bolt is unthreaded, the threaded portion of the bolt is retained against the threaded portion of the cover. One problem that may occur with this method is that in addition to a specially made bolt, a specially made cover is also required. While another problem that can occur with this design is that the bolt can bind against the threads in the cover when the bolt is being unthreaded.

### SUMMARY

One aspect of the present disclosure comprises captive fastener assembly and method comprising a retaining plate for positioning upon a perimeteral surface of a cover of an enclosure during use, the retaining plate comprising a plurality of plate openings having an inner diameter for the passage of a plurality of respective captive fasteners. The captive fastener assembly further comprises a plurality of respective securing rings having inner and outer diameters, the plurality of captive fasteners comprising an annular notch for fixedly attaching to the inner diameter of the securing ring during use, wherein the outer diameter of the securing rings is greater than the inner diameter of the plate openings.

Another aspect of the present disclosure comprises a method of securing first and second cover portions together to form an enclosure with a captive fastener assembly in order to retain a plurality of captive fasteners to the enclosure should any one of a plurality of captive fasteners become disengaged from the first or second cover portions, the method comprising the steps of: securing a retaining plate upon a perimeteral surface of a first cover of an enclosure during use, the retaining plate further comprising a plurality of plate openings having an inner diameter for the passage of a plurality of respective captive fasteners; providing a plurality of respective securing rings having inner and outer diameters, the plurality of captive fasteners comprising an annular notch for fixedly attaching to the inner diameter of the securing ring during use; and providing the outer diameter of the securing rings to have a greater diameter than the inner diameter of the plate openings such that the retaining plate retains the plurality of fasteners to the enclosure should any one of the plurality of fasteners become disengaged from the first and second cover portions.

While another aspect of the present disclosure includes an enclosure system having captive fastener assembly for securing a plurality of fasteners to an enclosure, the enclosure system comprising: first and second cover portions that when secured together by at least two captive fasteners form an enclosure, one of the first and second cover portions having a plurality of threaded openings and the other of the first and second cover portions having a plurality of pass-through openings, the pass-through openings being substantially concentrically aligned with the threaded openings in order to receive the at least two captive fasteners; a captive fastener assembly comprising: the at least two captive fasteners; a retaining plate for positioning upon a perimeteral surface the cover portion comprising the pass through openings, the retaining plate further comprising a plurality of plate openings having an inner diameter for the passage of the at least two fasteners; and a respective securing ring for fixedly attaching to each of the at least two captive fasteners, the securing rings having inner and outer diameters and the at least two captive fasteners comprising an annular notch for fixedly attaching to the inner diameter of the securing ring during use, wherein the outer diameter of the securing rings is greater than the inner diameter of the plate openings, such that the retaining plate retains the securing ring; and fixedly attached captive fasteners within the pass through-opening should any one of the captive fasteners become unthreaded from the threaded openings.

### BRIEF DESCRIPTION OF THE SEVERAL VIEWS OF THE DRAWINGS

The foregoing and other features and advantages of the present disclosure will become apparent to one skilled in the art to which the present disclosure relates upon consideration of the following description of the disclosure with reference to the accompanying drawings, wherein like reference numerals, unless otherwise described refer to like parts throughout the drawings and in which:

FIG. 1. is a first perspective view of an enclosure arrangement comprising a captive fastener assembly constructed in accordance with one example embodiment of the present disclosure;

FIG. 2 is a second perspective view of FIG. 1;

FIG. 3 is a top plan view of FIG. 1;

FIG. 4 is a bottom plan view of FIG. 1;

FIG. 5 is a lower front elevation view of FIG. 1;

FIG. 6 is an upper front elevation view of FIG. 1;

FIG. 7 is a first side elevation view of FIG. 1;

FIG. 8 is a second side elevation view of FIG. 1;

FIG. 9 is an exploded perspective assembly view of FIG. 1;

FIG. 10 is a partial perspective section assembly view of an enclosure arrangement comprising a captive fastener assembly constructed in accordance with another example embodiment of the present disclosure along section lines 10-10 and 11-11 in FIG. 3

FIG. 11 is a further partial perspective section assembly view of the enclosure arrangement comprising a captive fastener assembly of FIG. 10;

FIG. 12A illustrates a first step of a method of assembly of a captive fastener assembly in accordance with one example embodiment of the present disclosure;

FIG. 12B illustrates a second step of the method of assembly of FIG. 12A; and

FIG. 12C illustrates a third step of the method of assembly of FIG. 12A.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Referring now to the figures generally wherein like numbered features shown therein refer to like elements having similar characteristics and operational properties throughout unless otherwise noted. The present disclosure relates to a captive fastener assembly method and more specifically, a captive fastener assembly and method for securing first and second portions of a cover to form an enclosure arrangement with one more fasteners, while retaining said fasteners to the enclosure arrangement should any one of the fasteners become disengaged.

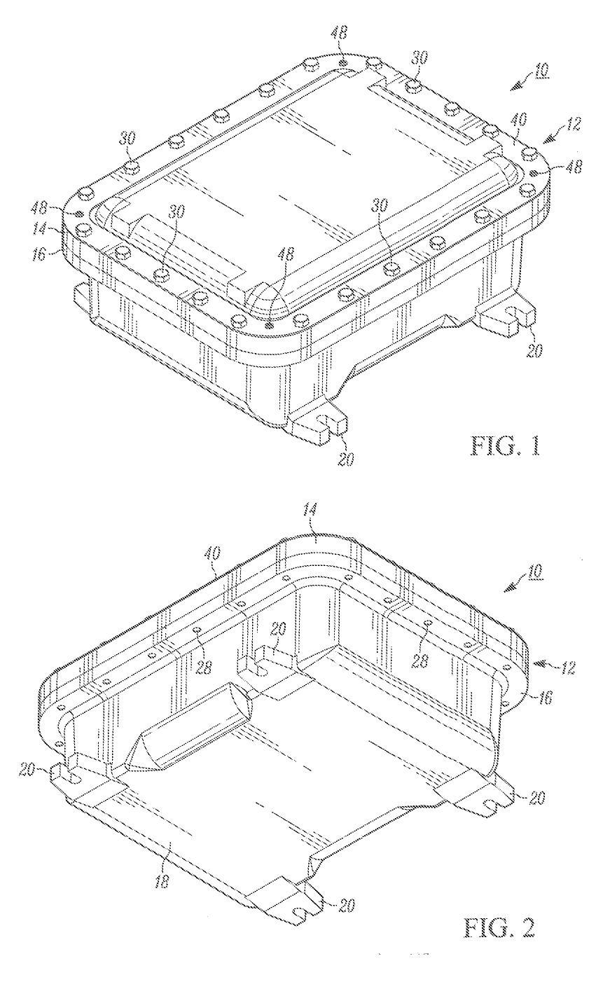

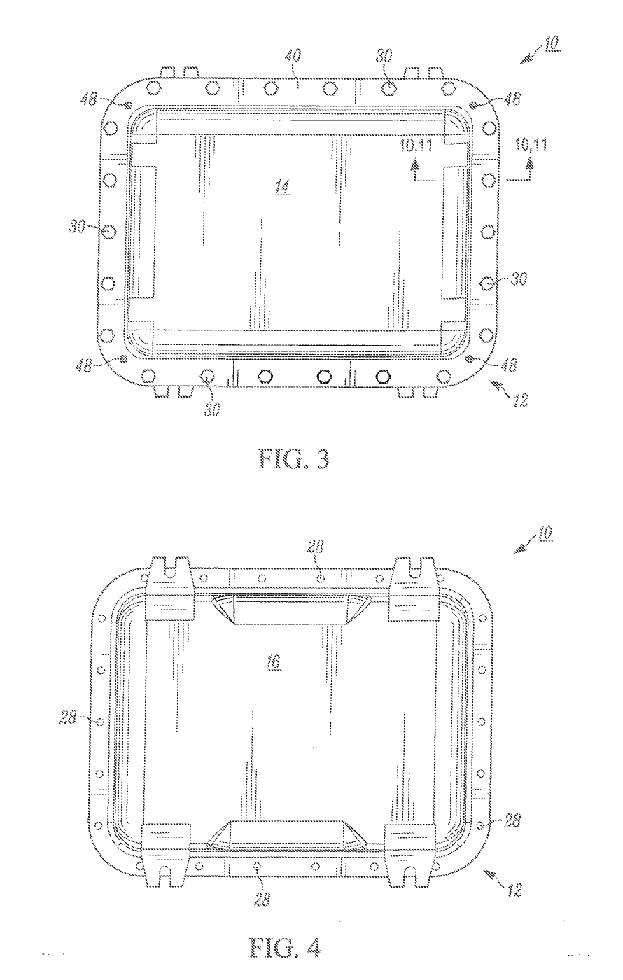

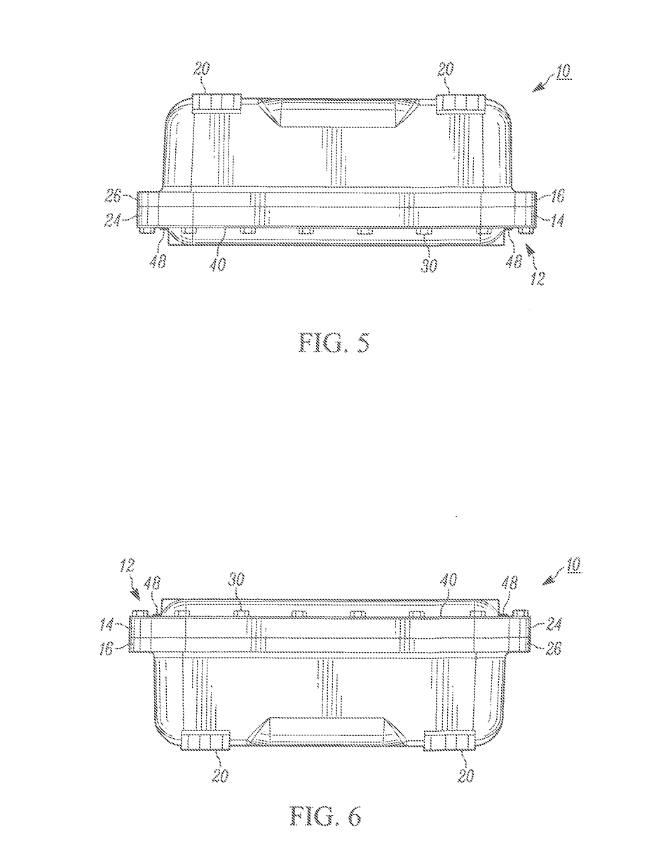

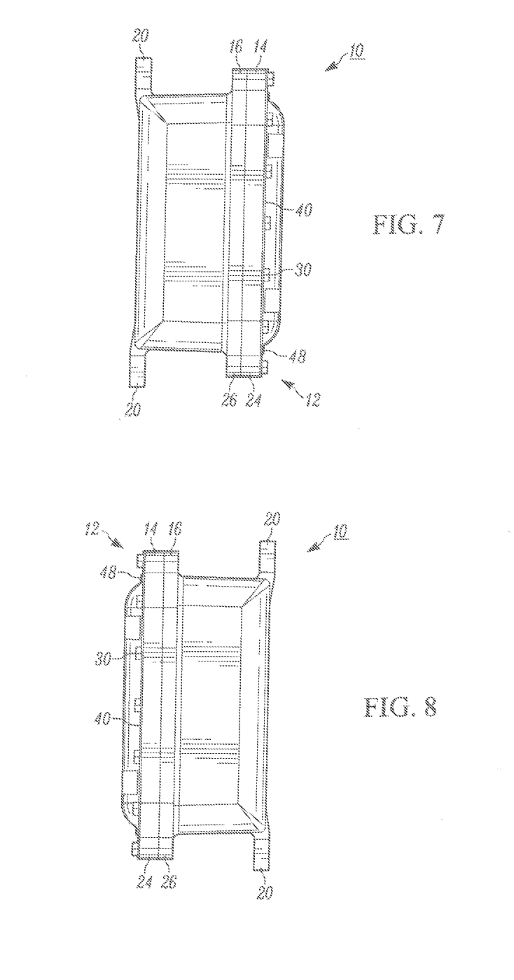

Referring now to FIGS. 1-12C, an enclosure arrangement 10 secured together with a captive fastener assembly 12. The enclosure arrangement 10 comprises first and second boxes or covers 14, 16, respectively. In one example embodiment, the enclosure arrangement 10 is a metal explosion proof and/or a dust tight enclosure made by Adalet, a Scott Fetzer Company and an assignee of the present disclosure. In another example embodiment, the enclosure 10 can be any type of container, case, trunk, or the like when it is desirable for the fasteners remain coupled to the enclosure.

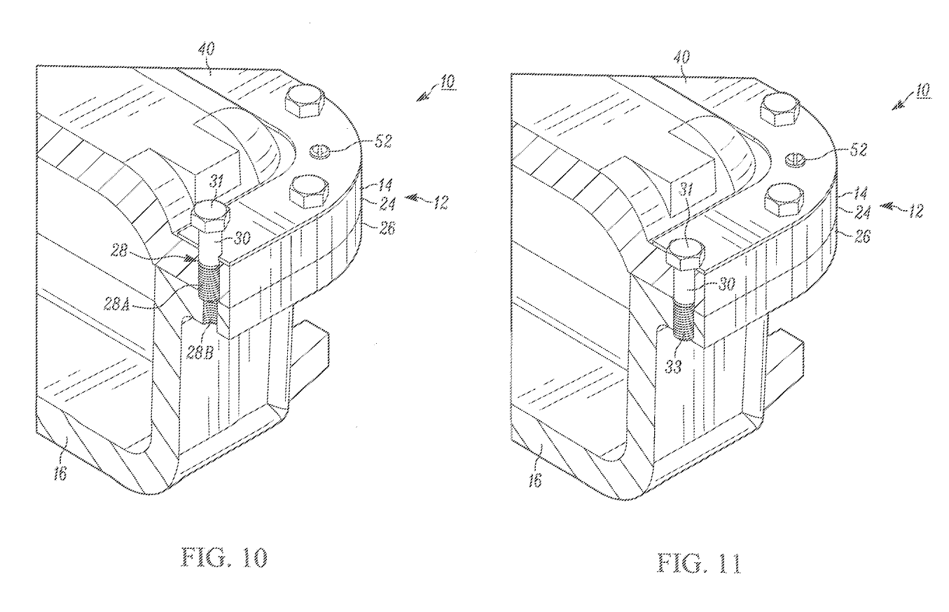

In one example embodiment, the covers 14 and 16 are made from metal, such as aluminum or stainless steel. The second cover 16 includes a base 18 with a plurality of tabs 20 for supporting the enclosure arrangement 10 to a surface such as a wall or floor with the use of fasteners as would be appreciated by one of ordinary skill in the art. Located and concealed during use between first and second covers 14, 16, is a cavity 22 (see FIG. 10) for housing motors, machines, and in the like.

Surrounding the perimeter of the first and second covers 14, 16 are respective first and second flanges 24, 26. The flanges 24, 26 support the captive fastener assembly 12. That is, the flanges include corresponding openings 28 for securing the first cover 14 to the second cover 16 via a plurality of fasteners 30. In one example embodiment, the fasteners are bolts, such as socket head cap screws, standard and quad lead bolts, or hex head bolts, that may include a shoulder or an unthreaded portion. The fasteners 30 in one example embodiment further comprise a head or cap 31 at a first end and a plurality of threads 33 at a second end.

The openings 28 include an oversized opening 28A through the first cover 14, which is oversized for the passage of the fastener 30, such as a drill through or counter-bored opening. While the openings 28B in the second cover are tapped-through openings for receiving the threaded portion of the fasteners 30.

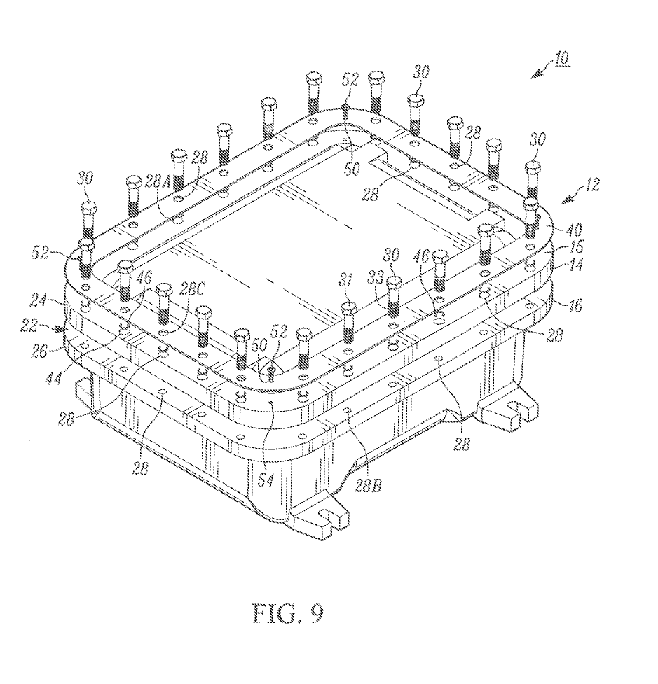

The captive fastener assembly 12 comprises a retaining plate 40 that surrounds the perimeter 15 of the first cover 14 along the first flange as illustrated in FIGS. 1 and 9. The retaining plate 40 includes corresponding openings 28 for the passages of the fasteners 30. In particular, the corresponding openings 28 forming the retaining openings 28C are spaced and correspond with the openings 28A and 28B in the first and second covers, 14 and 16, respectively. In one example embodiment, the retaining plate 40 is made of metal, such as, for example aluminum or stainless steel.

In the illustrated example embodiment, the retaining opening 28C diameter is smaller than the diameter of the first cover 14 opening 28A, but are slightly large enough to allow for the unrestrictive passage of the fastener 30 therethrough. The captive fastener assembly 12 further comprises modified fasteners 30 that include an annular notch 42. In one example embodiment, the annular notch 42 is an under-cut machined or turned into the fastener by a lathe. In one example embodiment, the notch 42 diameter of 0.4130+/−0.003 inches for a half-inch diameter size fastener 30.

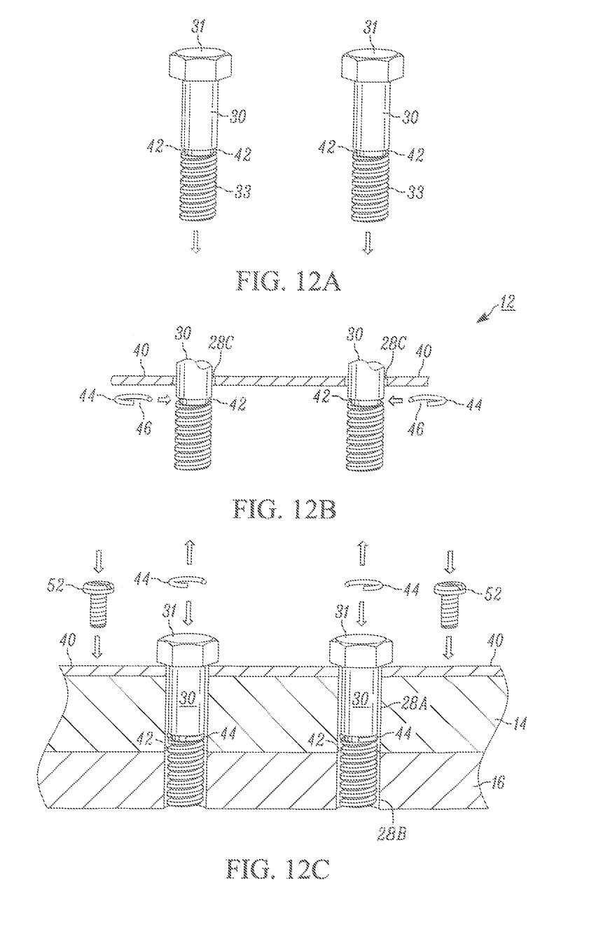

Also forming part of the captive fastener assembly 12 are securing rings 44. A securing ring 44 is positioned during assembly into each notch 42 of the fasteners 30. The securing ring 44 in one example embodiment is made from metal, such as stainless steel and has an outer diameter of 0.523+/−0.003 inches for securing into the 0.4130 inch diameter notch 42 in the example embodiment discussed above. In one example embodiment, the securing ring 44 is continuous, while in another example embodiment, the securing ring is a snap ring having an opening 46 (see FIGS. 9 and 12) to allow the ring to be snapped and held into the notch 42.

The captive fastener assembly 12, and more specifically the retaining plate 40 includes a plurality of holding points 48. The holding points 48 include in one example embodiment, a through hole 50 in the retaining plate 40 and a holding fastener 52 that corresponds to a tapped hole 54 in the first cover 14 beneath the retaining plate. The holding points 48 secure the retaining plate 40 to the perimeteral 15 surface of the first cover 14. In another example embodiment, the holding points 48 comprise a self tapping fastener 52, eliminating the need for a pre-drilled through hole 50 and tapped hole 54.

Referring now to FIGS. 10, 11, 12A, 12B, and 12C, is a method of installing a captive fastener assembly 12 on an enclosure arrangement 10 in accordance with one example embodiment of the present disclosure.

In the illustrated example embodiment, the fasteners 30 are first inserted first into openings 28C in the retaining plate 40 before the securing rings 44 are attached to the fasteners 30 about their respective notches 42 (either by a snap ring through opening 46 or by being placed about the fastener from the bottom up into the notch). The fasteners 30 are then placed into openings 28A of the first cover 14 and threaded into tapped openings 28B of the second cover 16.

The retaining plate 40 is then secured to the perimeteral surface of the first cover 14 by holding points 48. The securing rings 44 have an outer diameter smaller than the diameter of the opening or c'bore 28A, thus allowing free movement of the fastener 30 therein during the threading of the fasteners to the tapped opening 28B.

The securing rings 44, however, have an outer diameter that is larger than the diametrical opening 28C in the retaining plate 40. Thus, once the retaining plate 40 is secured to the first cover 14 by the holding points 48, the retaining plate and its small opening 28C prevent the passage of the securing ring 44 or their corresponding fasteners 30 from the openings 28. As such, should a fastener 30 become unthreaded from the tapped opening 28B, the captive fastener assembly 12, namely the retaining plate 40 and securing rings 44 prevent the fastener from leaving the opening 28, since the securing rings' diameter is larger, thus the securing rings' outer diameter is blocked by the smaller diameter of the corresponding openings 28C in the retaining plate.

The above construction and method of installation of the captive fastener assembly 12 advantageously allows numerous types of covers 10 to be used with this fastener securing design. Moreover, such design of the captive fastener assembly 12 provides for retro fitting existing covers and enclosure arrangements 10.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A captive fastener assembly comprising:
a retaining plate for positioning upon a perimeteral surface of a cover of an enclosure during use, the retaining plate further comprising a plurality of plate openings having an inner diameter for the passage of a plurality of respective captive fasteners; and
a plurality of respective securing rings having inner and outer diameters, said plurality of captive fasteners comprising an annular notch for fixedly attaching to said inner diameter of said securing ring during use;
wherein said outer diameter of said securing rings is greater than said inner diameter of said plate openings.

2. The captive fastener assembly of claim 1 wherein said plurality of captive fasteners further comprise a head at a first end and a plurality of threads at a second end wherein said retaining plate is positioned during assembly between said respective fastener head and said annular notch supporting said securing ring.

3. The captive fasteners assembly of claim 1 wherein said retaining plate further comprises at least one holding point comprising an opening for a holding fastener used to secure said retaining plate during use to a cover of an enclosure.

4. The captive fastener assembly of claim 1 wherein said retaining plate is positioned upon a perimeteral surface of an upper cover of an enclosure, the enclosure further formed by a lower cover, said upper cover having a pass-through opening and said lower cover having a threaded opening, said pass-through opening, plate opening, and threaded opening being substantially concentrically aligned.

5. The captive fastener assembly of claim 1 wherein said securing rings further comprise a less than semi-circular opening for attaching said securing ring to said annular notch.

6. The captive fastener assembly of claim 4 wherein the outer diameter of said securing ring is smaller than the diameter of said pass-through opening in said upper cover, allowing for the free inner movement of said fastener within said pass-through opening.

7. The captive fastener assembly of claim 1 wherein said securing ring and retaining plate are made from metal.

8. The captive fastener assembly of claim 1 wherein said plurality of captive fasteners further comprise a threaded portion and a smooth shank, said annular notch being positioned on said fasteners between said shank and threaded portion.

9. A method of securing first and second cover portions together to form an enclosure with a captive fastener assembly in order to retain a plurality of captive fasteners to the enclosure should any one of a plurality of captive fasteners become disengaged from said first or second cover portions, the method comprising the steps of:
securing a retaining plate upon a perimeteral surface of a first cover of an enclosure during use, the retaining plate further comprising a plurality of plate openings having an inner diameter for the passage of a plurality of respective captive fasteners;
providing a plurality of respective securing rings having inner and outer diameters, said plurality of captive fasteners comprising an annular notch for fixedly attaching to said inner diameter of said securing ring during use; and
providing said outer diameter of said securing rings so that the outer diameter is greater than said inner diameter of said plate openings such that said retaining plate retains said plurality of fasteners to said enclosure should any one of the plurality of fasteners become disengaged from said first or second cover portions.

10. The method of claim 9 further comprising the step of providing at least one holding point in said retaining plate comprising an opening for a holding fastener used to secure said retaining plate during use to one of said first and second cover portions forming said enclosure.

11. The method of claim 9 further comprising the step of substantially concentrically aligning said plate openings with a pass-through opening in said first cover portion and a threaded opening in said second cover portion.

12. The method of claim 9 further comprising the step of providing a less than semi-circular opening in said securing ring and attaching said securing ring to said annular notch in said plurality of captive fasteners.

13. The method of claim 11 further comprising the step of providing the outer diameter of said securing ring so that it is smaller than the diameter of said pass-through opening in said first cover portion, allowing for the free inner movement of said respective captive fastener within said pass-through opening.

14. The method of claim 9 further comprising the step of providing said plurality of captive fasteners with a threaded portion and a smooth shank, and positioning said annular notch between said shank and threaded portion.

15. An enclosure system having captive fastener assembly for securing a plurality of fasteners to an enclosure, the enclosure system comprising:
first and second cover portions that when secured together by at least two captive fasteners form an enclosure, one of said first and second cover portions having a plurality of threaded openings and the other of said first and second cover portions having a plurality of pass-through openings, the pass-through openings being substantially concentrically aligned with said threaded openings in order to receive said at least two captive fasteners;
a captive fastener assembly comprising:
said at least two captive fasteners;
a retaining plate for positioning upon a perimeteral surface said cover portion comprising said pass through openings, the retaining plate further comprising a plurality of plate openings having an inner diameter for the passage of said at least two fasteners; and
a respective securing ring for fixedly attaching to each of said at least two captive fasteners, said securing rings having inner and outer diameters and said at least two captive fasteners comprising an annular notch for fixedly attaching to said inner diameter of said securing ring during use, wherein said outer diameter of said securing rings is greater than said inner diameter of said plate openings, such that said retaining plate retains said securing ring and fixedly attached captive fasteners within said pass through-opening should any one of said captive fasteners become unthreaded from said threaded openings.

16. The enclosure system of claim 15 wherein said retaining plate further comprises at least one holding point comprising an opening for a holding fastener used to secure said retaining plate during use to one of said cover portions of said enclosure.

17. The enclosure system of claim 15 wherein said securing rings further comprise a less than semi-circular opening for attaching said securing ring to said annular notch.

18. The enclosure system of claim 15 wherein said at least two captive fasteners further comprise a threaded portion and a smooth shank, said annular notch being positioned on said fasteners between said shank and threaded portion.
